(19) United States
(12) Patent Application Publication
(10) Pub. No.: US 2016/0365102 A1
(43) Pub. Date: Dec. 15, 2016

(54) Conforming Fence For Vacuum Support Machining Operations

(71) Applicant: HGST Netherlands B.V., Amsterdam (NL)

(72) Inventors: Jacey R. Beaucage, San Jose, CA (US); Glenn P. Gee, San Jose, CA (US); Trevor W. Olson, San Jose, CA (US)

(21) Appl. No.: 14/736,186

(22) Filed: Jun. 10, 2015

(51) Int. Cl. G11B 5/187; B26D 7/01

(52) U.S. Cl. CPC G11B 5/187; B26D 7/01

(57) ABSTRACT

A process for slicing a row from an array of devices includes positioning an array such that a row physically interfaces with a conforming fence, applying a force to the fence to conform it to the mating face of the row, applying a vacuum force to the fence to secure it in conformal position with the row, and then slicing the row from the array. Applying the force to the fence to conform it to the row inhibits leakage associated with the vacuum force utilized to secure the fence with the row. A stronger hold of the row is provided, which can lead to more precise slicing of the row. A slicing tool includes a rotatable support that, in operation, is supported by an air bearing and hence is able to freely rotate to a position such that the fence conforms to a workpiece face.

### FIELD OF EMBODIMENTS

Embodiments of the invention may relate generally to thin film devices and more particularly to an approach to row slicing a set of devices from a larger array of devices.

### BACKGROUND

A hard-disk drive (HDD) is a non-volatile storage device that is housed in a protective enclosure and stores digitally encoded data on at least one circular disk having magnetic surfaces. When an HDD is in operation, each magnetic-recording disk is rapidly rotated by a spindle system. Data is read from and written to a magnetic-recording disk using a read-write head that is positioned over a specific location of a disk by an actuator. A read-write head uses a magnetic field to read data from and write data to the surface of a magnetic-recording disk. A write head makes use of the electricity flowing through a coil, which produces a magnetic field. Electrical pulses are sent to the write head, with different patterns of positive and negative currents. The current in the coil of the write head induces a magnetic field across the gap between the head and the magnetic disk, which in turn magnetizes a small area on the recording medium.

High volume magnetic thin film head slider fabrication involves high precision subtractive machining performed in discrete material removal steps. Slider processing starts with a completed thin film head wafer consisting of 40,000 or more devices, for example, and is completed when all the devices are individuated and meet numerous and stringent specifications. To balance the impact of material removal defects and artifacts on subsequent machining steps, specifications are required to be continuously improved. Of equal importance to improving the quality of material removal is to optimize the capacity of each material removal step in order to minimize capital equipment costs and cycle time.

In a typical first step of removal, a precision machining procedure is performed to individuate rows of devices from a wafer for batch processing, for example, usually an array of over 50 devices. These devices are then processed to final specifications through multiple removal steps, each with increasingly tight specifications. When slicing an array of rows from the wafer, there are limited means for providing cut support. However, cut support while machining directly impacts the quality of precision material removal.

Any approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF EMBODIMENTS

Embodiments of the invention are generally directed toward a process or method for slicing a row from an array of devices, and toward a corresponding slicing tool for slicing a workpiece. A slicing process comprises positioning an array of devices such that a row of the array physically interfaces with a conforming fence, applying a force to the fence sufficient to conform the fence to a mating face of the row, applying a vacuum force to the fence to secure the fence in conformal interfacing position with the row, and then slicing the row from the array. Applying the force to the fence to conform it to the mating face of the row acts to inhibit leakage that might be associated with applying the vacuum force to the fence to secure the fence with the row. Thus, a stronger hold of the row is provided, which can lead to a more precise slicing of the row. One non-limiting potential use of such a process may include the slicing of a row of magnetic read-write head sliders from a wafer array of such devices.

An embodiment of a slicing tool comprises a rotatable support bearing comprising a fence to interface with a workpiece face, where the fence includes a gas channel configured to provide a pressure differential at an outlet port, a housing for the support bearing, a gap between the support bearing and the housing, and a pressure chamber configured to transfer pressurized gas to the channel and whereby gas suffuses into the gap thereby providing an air bearing for the support bearing, which urges the support bearing to rotate to a position such that the fence of the support bearing conforms to the face of the workpiece.

Embodiments discussed in the Summary of Embodiments section are not meant to suggest, describe, or teach all the embodiments discussed herein. Thus, embodiments of the invention may contain additional or different features than those discussed in this section. Furthermore, no limitation, element, property, feature, advantage, attribute, or the like expressed in this section, which is not expressly recited in a claim, limits the scope of any claim in any way.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive (HDD), according to an embodiment;

FIG. 2 is an exploded perspective view illustrating a wafer of head sliders in various stages of processing, according to an embodiment;

FIG. 3 is a flow diagram illustrating a method for slicing a row from an array of devices, according to an embodiment;

FIG. 4 is a perspective view illustrating a slicing tool, according to an embodiment;

FIG. 5 is a flow diagram illustrating a method for slicing a row from an array of devices, according to an embodiment;

FIG. 6 is a cutaway perspective view illustrating a slicing tool having a conformal air bearing, according to an embodiment;

FIG. 7 is a cross-sectional side view illustrating the slicing tool of FIG. 6, with no workpiece present, according to an embodiment;

FIG. 8 is a cross-sectional side view illustrating the slicing tool of FIG. 6, with a workpiece present, according to an embodiment;

FIG. 9 is a cross-sectional side view illustrating the slicing tool of FIG. 6, with a workpiece present, according to an embodiment; and

FIG. 10 is a side view illustrating a conforming fence, according to an embodiment.

### DETAILED DESCRIPTION

Approaches to slicing a row from an array of devices are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### Physical Description of Illustrative Operating Context

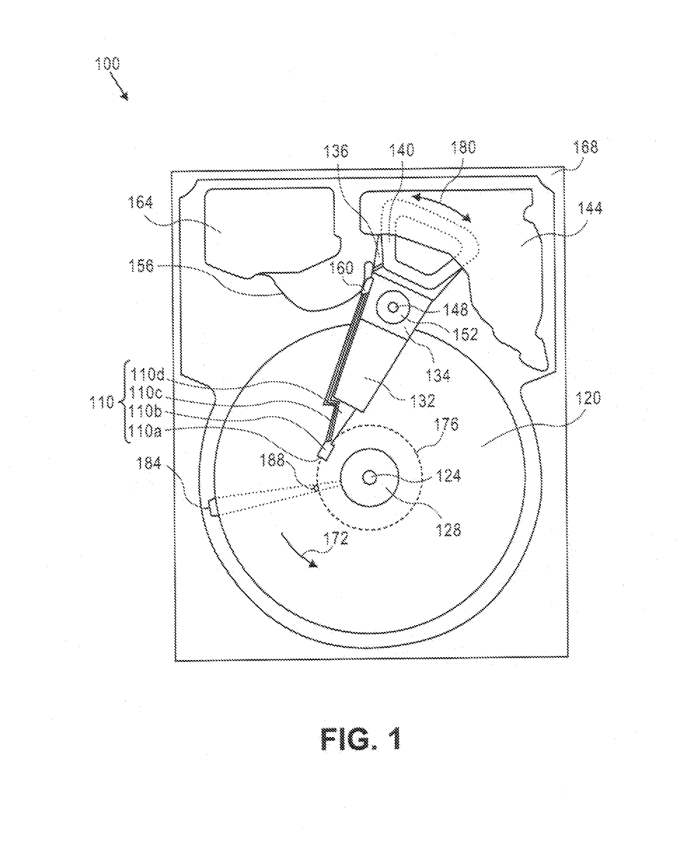

Embodiments may be used in the context of slicing a row of magnetic read-write head sliders from a wafer, such as for use in a hard disk drive (HDD) storage device. Thus, in accordance with an embodiment, a plan view illustrating an HDD 100 is shown in FIG. 1 to illustrate an exemplary operating context.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one magnetic-recording medium 120 rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134, a voice-coil motor (VCM) that includes an armature 136 including a voice coil 140 attached to the carriage 134 and a stator 144 including a voice-coil magnet (not visible). The armature 136 of the VCM is attached to the carriage 134 and is configured to move the arm 132 and the HGA 110, to access portions of the medium 120, being mounted on a pivot-shaft 148 with an interposed pivot bearing assembly 152. In the case of an HDD having multiple disks, the carriage 134 is called an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator coil (e.g., the VCM) to which the actuator arm is coupled, may be collectively referred to as a head stack assembly (HSA). An HSA may, however, include more or fewer components than those described. For example, an HSA may refer to an assembly that further includes electrical interconnection components, a preamplifier, etc. Generally, an HSA is the assembly configured to move the head slider to access portions of the medium 120 for read and write operations.

With further reference to FIG. 1, electrical signals (e.g., current to the voice coil 140 of the VCM) comprising a write signal to and a read signal from the head 110a, are provided by a flexible interconnect cable 156 (“flex cable”). Interconnection between the flex cable 156 and the head 110a may be provided by an arm-electronics (AE) module 160, which may have an on-board pre-amplifier for the read signal, as well as other read-channel and write-channel electronic components (collectively, and generally, “data channel”). The AE module 160 may be attached to the carriage 134 as shown. The flex cable 156 is coupled to an electrical-connector block 164, which provides electrical communication through electrical feedthroughs provided by an HDD housing 168. The HDD housing 168, also referred to as a base, in conjunction with an HDD cover provides a sealed, protective enclosure for the information storage components of the HDD 100.

Other electronic components, including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the medium 120 that is affixed to the spindle 124. As a result, the medium 120 spins in a direction 172. The spinning medium 120 creates a cushion of air that acts as an air-bearing on which the air-bearing surface (ABS) of the slider 110b rides so that the slider 110b flies above the surface of the medium 120 without making contact with a thin magnetic-recording layer in which information is recorded. Similarly in an HDD in which a lighter-than-air gas is utilized, such as helium for a non-limiting example, the spinning medium 120 creates a cushion of gas that acts as a gas or fluid bearing on which the slider 110b rides.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested tracks arranged in sectors on the medium 120, such as sector 184. Correspondingly, each track is composed of a plurality of sectored track portions (or “track sector”), for example, sectored track portion 188. Each sectored track portion 188 may be composed of recorded data and a header containing a servo-burst-signal pattern, for example, an ABCD-servo-burst-signal pattern, which is information that identifies the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the track 176. Upon finding the track 176 and identifying a particular sectored track portion 188, the head 110a either reads data from the track 176 or writes data to the track 176 depending on instructions received by the disk controller from an external agent, for example, a microprocessor of a computer system.

An HDD's electronic architecture comprises numerous electronic components for performing their respective functions for operation of an HDD, such as a hard disk controller (“HDC”), an interface controller, an arm electronics module, a data channel, a motor driver, a servo processor, buffer memory, etc. Two or more of such components may be combined on a single integrated circuit board referred to as a “system on a chip” (“SOC”). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass a data storage device that is at times referred to as a “hybrid drive”. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management and control of the different types of storage media typically differs, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### Introduction

Slider processing starts with a completed thin film head wafer consisting of 40,000 or more devices, and is completed when all the devices are individuated and meet numerous and stringent specifications. The individual devices ultimately become read-write heads. As mentioned, high volume magnetic thin film head slider fabrication involves high precision subtractive machining performed in discrete material removal steps. Precise control of the read head and write head dimensions and of the alignment of the read and write portions of the head relative to each other are critical components of the read-write head fabrication process, in order to achieve optimum yield, performance and stability.

In the first step of removal, a precision machining procedure is performed to individuate rows of devices for batch processing, usually an array of over 50 devices. These devices are then processed to final specifications through multiple removal steps, each with increasingly tight specifications. To balance the impact of material removal defects or artifacts on the following machining steps, read-write transducer parameters are continuously improved as the removal processes proceed. Of equal importance to improving the quality of material removal is to optimize the capacity of each material removal step in order to minimize capital equipment costs and cycle time.

When slicing an array of rows, there are limited means of providing cut support, where the cut support while machining directly impacts the quality of precision material removal. One approach to providing cut support involves the adhesive bonding of a wafer to a fixture or sacrificial substrate. This approach may provide adequate cut support as well as high volume capacity. However, issues with using a bonding agent and a sacrificial material remain, such as with the solvents, heat and tooling typically involved with removing bonding adhesives from the wafer, the significant cycle time associated with bonding and de-bonding wafers, and the devices being machined are inherently prone to corrosion which may be promoted by corrosive agents within the adhesive.

To avoid the foregoing undesirable conditions associated with machining bonded parts, another approach involves using vacuum as a medium of cut support, which provides cut support without using adhesives or solvents, and without realizing the resulting increase in cycle time. However, even with use of vacuum cut support, the precision of cuts is not necessarily as high quality as desired.

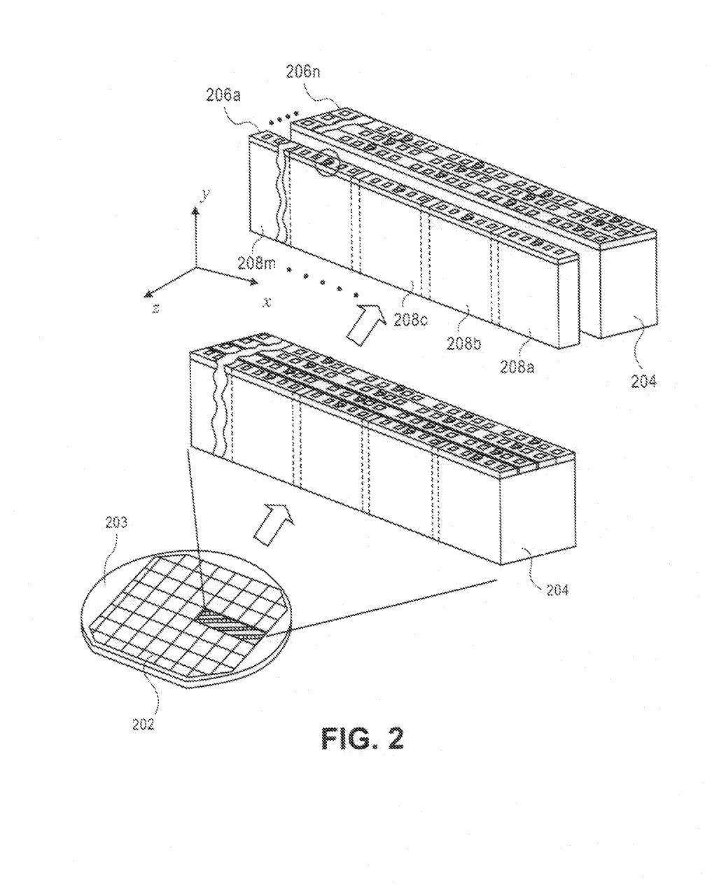

FIG. 2 is an exploded perspective view illustrating a wafer of head sliders in various stages of processing, according to an embodiment. FIG. 2 depicts a wafer 202, comprising a matrix of unfinished head sliders having unfinished read-write transducers deposited on a substrate 203, for which AlTiC is commonly used. The matrix of sliders is typically processed in batches, i.e., subsets of the wafer, historically referred to as “quads” and now at times referred to as “chunks” or “blocks”. A block of unfinished head sliders, block 204, comprises multiple rows 206a-206n (or “bars”, or “row-bars”) of unfinished head sliders, where n represents a number of row-bars per block 204 that may vary from implementation to implementation. Each row 206a-206n comprises multiple head sliders 208a-208m, where m represents a number of head sliders per row 206a-206n that may vary from implementation to implementation.

One approach to row slicing (or “bar slicing” or “row-bar slicing”) involves seating row arrays against a vacuum fence. Vacuum is actuated and provides cut support below the part, and at the interface in front of the row to be removed. The interface of concern is the air bearing surface (ABS) faces of the sliders and the vacuum fence. At this interface, the quality of uninterrupted vacuum directly impacts the precision and quality of the cut. Cutting forces, coolant flow, and the mating of the ABS to the vacuum fence represent significant challenges. The incoming angle of the row to be cut directly impacts the interface between the wafer/ABS and the vacuum fence.

Using a fence made of conforming material that seals the wafer against the fence, while providing conformality, may not provide sufficient datum rigidity and may therefore result in loss of cutting precision. On the other hand, using a rigid fence for a datum does not accommodate the incoming angle of the row, whereby any gaps in the ABS-fence interface is likely to result in a loss of vacuum and, consequently, a loss of cut support. However, is has been common practice to provide a rigid datum and accept the loss of vacuum during precision machining that results from the workpiece-fence surfaces not precisely mating.

### Head Slider Fabrication Processes

A typical head slider fabrication process flow may include the following: a wafer (e.g., wafer 202 of FIG. 2) fabrication process, which includes deposition of the reader and writer elements, followed by block (or “quad”) slicing to remove a block (e.g., block 204 of FIG. 2) of unfinished sliders from the wafer. An outer row (e.g., row 206a of FIG. 2) of sliders (e.g., head sliders 208a-208m of FIG. 2) from the block may then be rough lapped (e.g., wedge angle lapped) in order to fabricate the desired reader and writer dimensions, and then the outer rough-lapped row (e.g., row 206a) sliced from the block (e.g., block 204). From there, the row may be further lapped, such as “back-lapped” to form the flexure-side surface opposing the air bearing surface (ABS), and “ABS fine-lapped” to further refine the ABS surface. This then may lead to overcoating, and rail etching, etc. of the ABS surface to form the final air bearing or flying surface, at which point each head slider (e.g., head sliders 208a-208m) may be diced or parted from the row to individuate each finished head slider, whereby it can then be coupled with a flexure, assembled into a head-gimbal assembly (HGA), and so on.

### Process for Slicing a Row from an Array

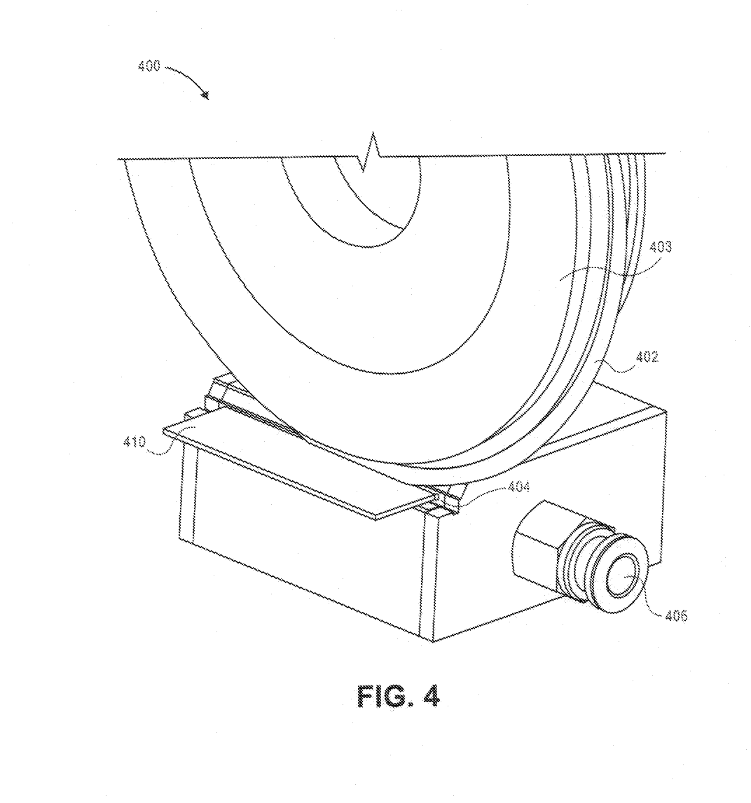

FIG. 4 is a perspective view illustrating a slicing tool, according to an embodiment. Slicing tool 400 comprises a blade 402 supported in a housing 403, a conforming fence 404 configured to support an array of devices 410 (generally, “a workpiece”) for slicing by the blade 402, and an air/gas pressure port 406 for the transfer of pressurized air or gas therethrough.

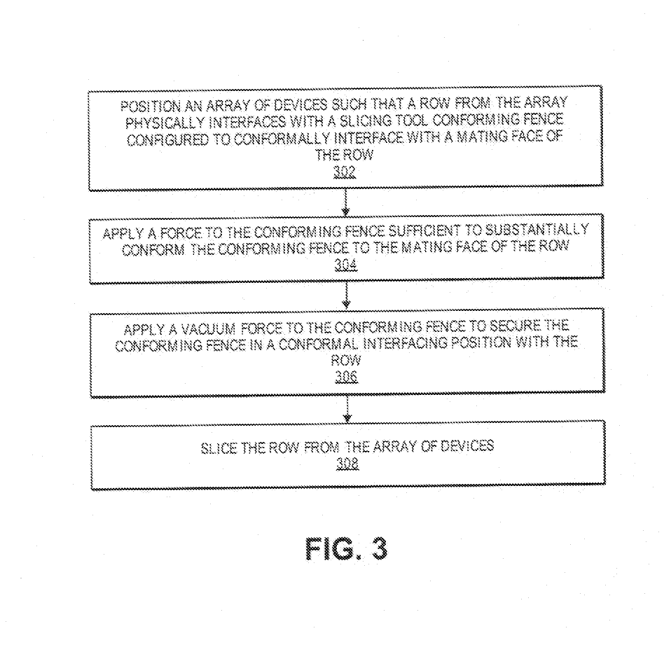

FIG. 3 is a flow diagram illustrating a method for slicing a row from an array of devices, according to an embodiment.

At block 302 an array of devices is positioned such that a row physically interfaces with a slicing tool conforming fence (i.e., a conforming fence of a slicing tool) that is configured to conformally interface with a mating face of the row. For example, array 410 (FIG. 4) (see also block 204 of FIG. 2) is positioned in a slicing tool (see, e.g., slicing tool 400 of FIG. 4) such that a row of devices is mated with conforming fence 404 (FIG. 4). The manner in which the conforming fence is configured to conformally interface with a mating face of the row may vary from implementation to implementation. Multiple embodiments are described in more detail herein, but practice of the method of FIG. 3 is not limited to the details of the embodiments described hereafter.

At block 304, a force is applied to the conforming fence where the force is sufficient to substantially conform the conforming fence to the mating face of the row. The manner in which the conforming fence is made to conform to the mating face of the row may vary from implementation to implementation. For non-limiting examples, a pressurized gas force or a spring force may be applied to the conforming fence in order to position the fence such that it conforms to the mating face of the row. Multiple embodiments are described in more detail herein, but practice of the method of FIG. 3 is not limited to the details of the embodiments described hereafter.

While the force applied generally conforms the fence to the row, the term “substantially” is used because of the variation, or deviation from the plane, associated with the mating face of the row. That is, the face of the row is not usually perfectly planar or flat as there is effectively always some deviation from the plane at various locations across the face due to the fabrication and slicing processes (e.g., perhaps 1° or more), and in the context of the micro-scale of such devices (e.g., a 180 micron height row). Thus, at such a micro-scale it is not feasible to completely, perfectly or precisely conform due to this micro-variation, but substantially conforming eliminates a significant portion of mismatch or non-conformity between the face of the fence and the face of the row, and consequently provides for a better, less leaky vacuum at block 306.

At block 306 a vacuum (force) is applied to the conforming fence to secure the conforming fence in a conformal interfacing position with the row. For example, a vacuum may be pulled on conforming fence 404 (FIG. 4) via pressure port 406 (FIG. 4), thereby locking or securing the fence in its conformal position to the row face. Because the conforming fence 404 is made to substantially conform to the mating face of the row of array 410, thereby inhibiting gas leakage from the interface of the fence 404 and the row of the array 410 while the vacuum force is present, a relatively tight securing of the fence-row interface is facilitated, even while the row is being sliced from the array.

At block 308 the row is sliced from the array of devices. Thus, because of the relatively tight securing of the row resulting from the conformal fence-row interface, even the already sliced portion of the row is better secured than with non-conformal fence approaches, thereby facilitating a more precise slicing or cutting operation than if the sliced portion of the row was less secured. Effectively, the blade 402 (FIG. 4) is interacting with a more rigid structure due to the more robust securing mechanism, as compared to a non-conformal fence, and therefore the blade is less likely to deviate from a straight line as it is moving down the row while slicing.

### Air Bearing Support for Slicing a Row from an Array

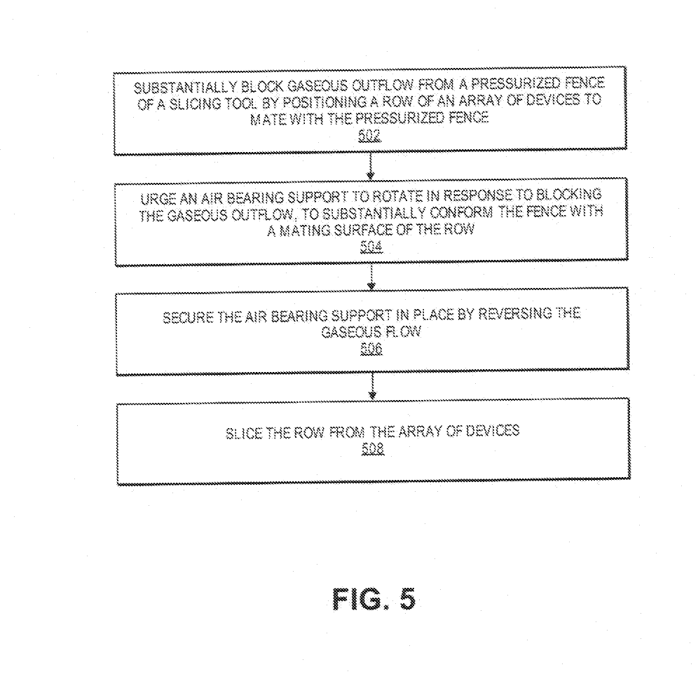

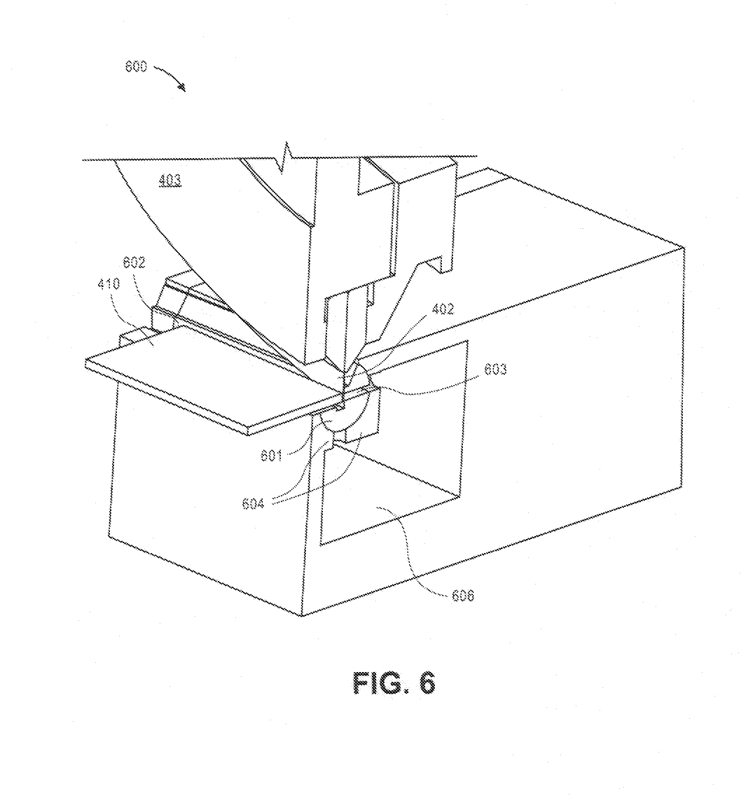

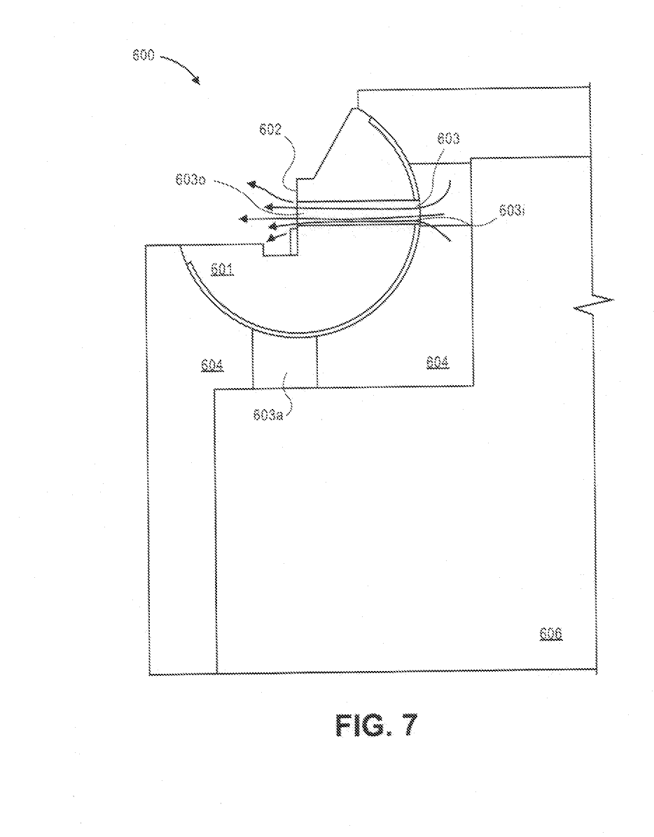

FIG. 6 is a cutaway perspective view illustrating a slicing tool having a conformal air bearing, and FIG. 7 is a cross-sectional side view illustrating the slicing tool of FIG. 6 with no workpiece present, both according to an embodiment. The process illustrated in FIG. 5 may be performed with an apparatus such as slicing tool 600 illustrated in FIG. 6.

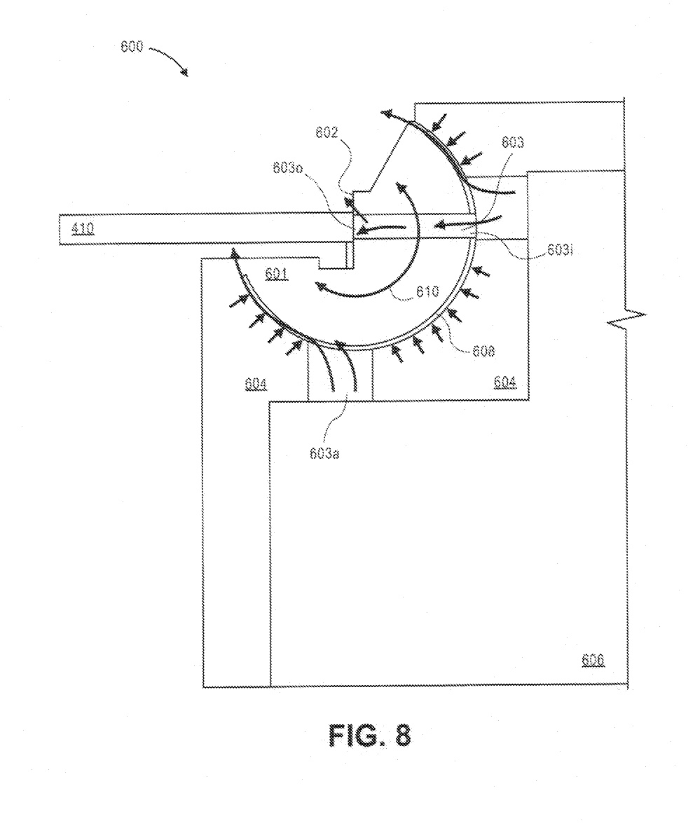

With reference first to FIG. 6, slicing tool 600 comprises a rotatable bearing support 601 (also referred to herein as “an air bearing support”) configured to provide support to a workpiece during slicing by blade 402. The rotatable support bearing 601 comprises a fence 602 that is configured to interface with a face of the array 410 (generally, “workpiece”). The fence 602 comprises a gas channel 603 having an outlet port 603o (see, e.g., FIG. 7) and an inlet port 603i (see, e.g., FIG. 7), whereby the gas channel 603 is configured to provide a pressure differential at the outlet port 603o. The support bearing 601 is supported or housed by a housing 604, and a gap 608 (see, e.g., FIG. 8) is present between the support bearing 601 and the housing 604. Further, the gas channel 603 can be pressurized by way of a pressure chamber 606 that is configured to contain and to transfer pressurized gas to the gas channel 603 through the gas channel inlet port 603i.

FIG. 5 is a flow diagram illustrating a method for slicing a row from an array of devices, according to an embodiment. At block 502 gaseous outflow from a pressurized fence of a slicing tool is substantially blocked by positioning a row of the array of devices to mate with the pressurized fence. For example and with reference to FIG. 6 and FIG. 7, the pressure chamber 606 may be pressurized via a port such as port 406 (FIG. 4). The pressurized gas, such as air, flows into the channel 603 (and can further flow into an optional channel 603a), which is constituent to an air bearing support 601 (also referred to herein as “a rotatable support bearing”). The pressurized gas flows into a channel inlet port 603i and out of a channel outlet port 603o. When air/gas pressure is applied to the pressure chamber 606 and thus to the channel 603 and when no array of devices or other workpiece is present, then the gas flows out of the outlet port 603o, as depicted in FIG. 7 by the arrows exiting outlet port 603o of channel 603. With reference to the slicing tool 600 of FIG. 6, an array 410 may be positioned to mate with the pressurized fence 602 of air bearing support 601.

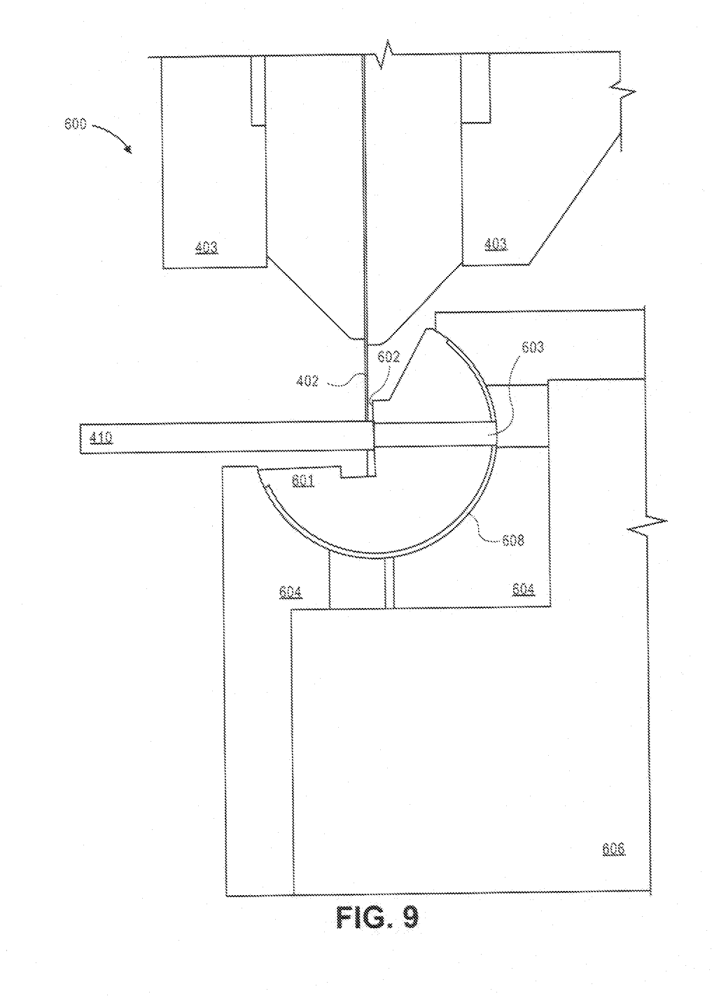

FIG. 8 is a cross-sectional side view illustrating the slicing tool of FIG. 4, with a workpiece present, and FIG. 9 is a cross-sectional side view illustrating the slicing tool of FIG. 4, with a workpiece present, both according to an embodiment.

Returning to FIG. 5, at block 504 an air bearing support is urged to rotate in response to blocking the gaseous outflow (block 502) in order to substantially conform the pressurized fence to a mating surface of the row. For example, air bearing support 601 is urged to rotate in response to the array 410 blocking the gaseous outflow from channel outlet port 603o. When the array 410 presses up against the pressurized fence 602, a seal (or at least a partial seal) is generated and the pressurized gas tends to flow elsewhere, including suffusing into and filling the gap 608 between the air bearing support 601 and the corresponding housing 604, thereby creating, generating, pressurizing an air bearing to support the air bearing support 601. This suffusion of the pressurized gas is depicted in FIG. 8 as the bold arrows in and around the gap 608.

Because the air bearing support 601 is now being supported or held up by an actual air bearing generated in the gap 608, near-frictionless rotational movement 610 of the air bearing support 601, and its constituent pressurized fence 602, is now possible. Thus, by the nature of the near-frictionless air bearing supported state of the support 601, in conjunction with the interfacial interaction between the array 410 and the pressurized fence 602 of the air bearing support 601, the air bearing support 601 is urged to rotate such that the pressurized fence is forced to substantially conform with the mating surface of the row of the array of devices (i.e., array 410). Stated otherwise, urging the air bearing support 601 to rotate effectively causes the fence to self-align in conformance with the mating surface of the row. Thus, the mating surface or face of the row can reference to, i.e., evenly make contact with, the fence 602, hence resulting in robust support of the row before and during subsequent slicing.

With reference to FIG. 9 and in the context of block 504, note that the air bearing support 601 is rotated slightly counter-clockwise from its neutral position (see, e.g., FIG. 7), to illustrate an example of the associated rotational movement 610 (FIG. 8) to more tightly interface the row face/array 410 with the supporting fence 602. According to an embodiment, the slicing tool 600 is equipped with one or more limiter structures configured to limit the degree of rotation of the rotatable support bearing, e.g., the air bearing support 601.

With further reference to FIG. 5, at block 506 the air bearing support is secured in place by reversing the gaseous flow. For example, the pressurized flow from pressure chamber 606 (FIG. 9) is reversed, i.e., a vacuum is pulled, thereby locking the air bearing support 601 (FIG. 9) into place as rotated, which in turn locks the pressurized fence 602 in place conformal with the row face.

At block 508 the row is sliced from the array of devices, e.g., from the array 410 (FIG. 9). One effect of more securely supporting and holding in place the row, at least in part by inhibiting and reducing leakage from the securing vacuum force by way of providing a more conformal fit between the array 410 and the pressurized fence 602, is that while the blade 402 travels down the length of the row for slicing, the portion of the row that is already sliced and separated from the remainder of the body of the array/wafer/workpiece is still held tightly in place by the vacuum force, specifically, and by the pressurized fence 602 and air bearing support 601, generally.

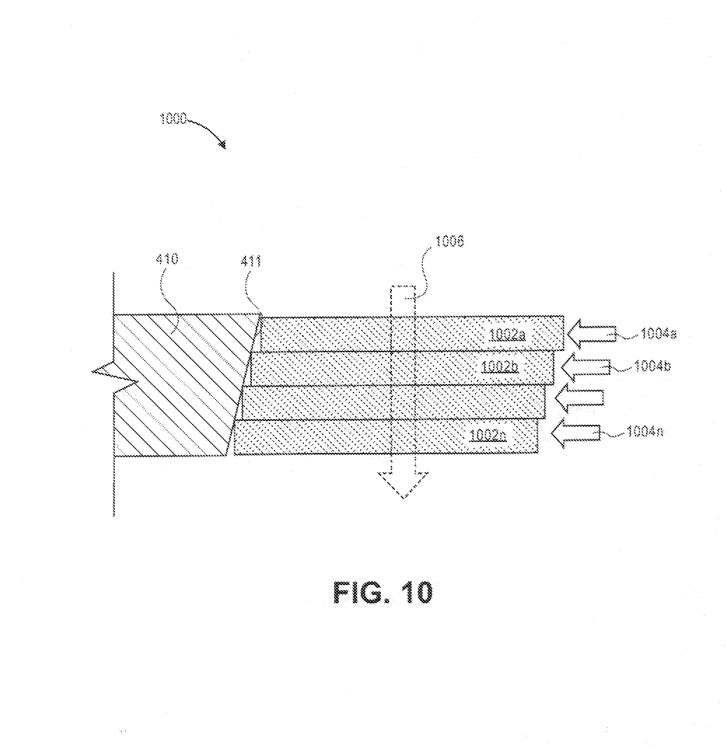

FIG. 10 is a side view illustrating a conforming fence, according to an embodiment. Conforming fence 1000 illustrates an alternative embodiment to the “rotatable air bearing” embodiment described in reference to FIGS. 5-9, but an embodiment consistent with the slicing tool 400 (FIG. 4) and that may be used to perform the process described in reference to FIG. 3.

Conforming fence 1000 is configured to interface with and provide support to a workpiece, such a wafer array of devices, during slicing. Conforming fence 1000 comprises two or more segments 1002a, 1002b-1002n, where the number of segments may vary from implementation to implementation. Each of the segments 1002a-1002n is configured to move independently of the other segments. For example, small gaps may be implemented between adjacent segments 1002a-1002n such that the segments are able to slide freely relative to each other.

Conforming fence 1000 further comprises a force mechanism configured to apply a force sufficient to conform each of the segments 1002a-1002n to a respective mating portion of a face 411 of array 410. For example, the force applied to each of the segments 1002a, 1002b-1002n may be a respective spring force 1004a, 1004b-1004n that operates to conform each corresponding segment 1002a, 1002b-1002n to the face 411.

Conforming fence 1000 further comprises a vacuum actuation mechanism configured to secure each of the segments 1002a-1002n in place in a conformal position with each respective mating portion of the face 411 of the array 410. For example, the vacuum force 1006 applied to each of the segments 1002a, 1002b-1002n to effectively couple the segments 1002a-1002n together to lock them in place against the face 411 of the array 410 may be implemented as a pressure chamber internal to a portion of each segment, whereby creating a vacuum in the pressure chamber effectively locks in place each of the segments 1002a-1002n so that each segment is inhibited from further movement under the influence of the respective spring force 1004a-1004n.

### Extensions and Alternatives

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

What is claimed is:

1. A method for slicing a row from an array of devices, the method comprising:
positioning said array of devices such that said row physically interfaces with a slicing tool conforming fence configured to conformally interface with a mating face of said row;
applying a force to said conforming fence sufficient to substantially conform said conforming fence to said mating face of said row;
applying a vacuum force to said conforming fence to secure said conforming fence in a conformal interfacing position with said row; and
slicing said row from said array of devices.

2. The method of claim 1, wherein said positioning, applying said force, and applying said vacuum force includes performing said actions on said conforming fence comprising a rotatable air bearing having a face configured to conformally mate with said mating face of said row when said air bearing rotates into conformance with said mating face of said row.

3. The method of claim 1, wherein said positioning, applying said force, and applying said vacuum force includes performing said actions on said conforming fence comprising two or more segments each configured to move independently of the other segments, in response to said applying said force, into conformance with a corresponding portion of said mating face of said row.

4. The method of claim 1, wherein said applying said force to said conforming fence sufficient to substantially conform said fence to said mating face of said row acts to inhibit leakage associated with said applying said vacuum force to said fence to secure said fence with said row.

5. A method for slicing a row from an array of devices, the method comprising:
substantially blocking gaseous outflow from a pressurized fence of a slicing tool by positioning said row of said array of devices to mate with said pressurized fence;
urging an air bearing support to rotate in response to blocking said gaseous outflow, to substantially conform said pressurized fence with a mating surface of said row;
securing said air bearing support in place by reversing said gaseous flow; and
slicing said row from said array of devices.

6. The method of claim 5, wherein urging said air bearing support to rotate includes suffusing said gaseous flow into a gap between said air bearing support and a corresponding housing to pressurize said air bearing.

7. The method of claim 6, wherein urging said air bearing support to rotate includes causing said fence to self-align in conformance with said mating surface of said row.

8. The method of claim 5, wherein reversing said gaseous flow comprises securing a sliced portion of said row in place while slicing said row from said array of devices.

9. The method of claim 5, wherein urging said air bearing support to rotate acts to inhibit leakage associated with reversing said gaseous flow to secure said air bearing support in place.

10. A slicing tool comprising:
a rotatable support bearing configured to interface with and provide support to a workpiece during slicing, said support bearing comprising a fence configured to interface with a face of said workpiece, said fence comprising a gas channel having an outlet port and an inlet port, said gas channel configured to provide a pressure differential at said outlet port;
a housing for said support bearing;
a gap between said support bearing and said housing;
a pressure chamber configured to contain and transfer pressurized gas to said gas channel through said inlet port, wherein when said workpiece is positioned to interface with said fence said outlet port is blocked and pressurized gas from said pressure chamber suffuses into said gap to provide an air bearing for said support bearing and urges said support bearing to rotate to a position that conforms said fence of said support bearing to said face of said workpiece; and
a blade configured to slice off a portion of said workpiece.

11. The slicing tool of claim 10, wherein said pressure chamber is further configured to provide for reversing the flow of said pressurized gas to secure said support bearing in said position that conforms said fence to said face.

12. The slicing tool of claim 10, wherein said pressure chamber is further configured to provide for reversing the flow of said pressurized gas to secure a sliced portion of said workpiece in place while slicing said portion from said workpiece.

13. The slicing tool of claim 10, further comprising:
one or more limiter structure configured to limit the degree of rotation of said support bearing.
